(19) United States
(12) Patent Application Publication
(10) Pub. No.: US 2026/0265432 A1
(43) Pub. Date: Sep. 10, 2026

(54) ENAMINES AS INITIATORS IN THE HARDENING OF RADICALLY HARDENING REACTIVE RESINS FOR CHEMICAL FASTENING

(71) Applicant: Hilti Aktiengesellschaft, Schaan (LI)

(72) Inventors: Thomas Bürgel, Landsberg (DE); Vanessa Sirch, Schwabmuenchen (DE); Norbert Moszner, Triesen (LI)

(73) Assignee: Hilti Aktiengesellschaft, Schaan (LI)

(21) Appl. No.: 19/165,786

(22) PCT Filed: Mar. 25, 2024
(86) PCT No.: PCT/EP2024/057918

§ 371 Date: Sep. 16, 2025

(30) Foreign Application Priority Data
Apr. 5, 2023 (EP) 23166786.6

(51) Int. Cl. C08F 220/34; C04B 26/06; C04B 111/00

(52) U.S. Cl. CPC C08F 220/343; C04B 26/06; C04B 2111/00715

(57) ABSTRACT

A hardener system for radically polymerizable compounds comprises an enamine and a transition metal in the form of a salt or a complex and can be used for chemical fastening. Furthermore, a reactive resin system comprising the hardener system and a multi-component reactive resin system comprising the hardener system can be used for chemical fastening.

The present invention relates to a hardener system for a reactive resin system which contains radically polymerizable compounds, wherein the hardener system comprises an enamine and a transition metal in the form of a salt or a complex, a reactive resin system containing this hardener system and a multi-component reactive resin system containing this hardener system, and the use thereof, in particular for chemical fastening.

The use of reactive resin mixtures based on radically polymerizable compounds has long been known. In the field of fastening technology, the use of reactive resin mixtures as organic binders has gained acceptance in chemical fastening technology. These are often two-component systems, wherein the A component contains the reactive resin mixture and the B component contains the hardening agent. Other common constituents such as fillers, accelerators, stabilizers thixotropic agents, phlegmatizers, solvents, including reactive solvents, can be contained in one and/or the other component. By mixing the two components, the reaction is then initiated by radical formation and the resin is hardened to form duromers.

Radically hardening systems, in particular systems which cure at room temperature, require so-called radical starters, also called initiators, so that the radical polymerization can be triggered. In the field of chemical fastening technology, the hardener composition described in application DE 3226602 A1, comprising benzoyl peroxide as a radical starter and an aminic compound as an accelerator, and the hardener composition described in the application EP 1586569 A1, comprising a perester as a hardener and a metal compound as an accelerator, have gained acceptance because of their properties.

These hardener compositions allow rapid and quite complete curing even at very low temperatures down to −30° C. In addition, these systems are very robust with regard to the mixing ratios of reactive resin and hardener. Thus, they are suitable for use under construction site conditions.

However, a disadvantage of these hardener compositions is that peroxides are used as radical starters in both cases. These are thermally sensitive and react very sensitively to impurities. This leads to considerable limitations in the formulation of pasty hardener components, primarily for injection mortars with respect to storage temperatures, storage stability and the selection of suitable components. To enable the use of peroxides, such as dibenzoyl peroxide, peresters and the like, phlegmatizers, such as phthalates or water, are added to stabilize them. However, these significantly impair the mechanical performance of reactive resin mixtures when used, for example as reaction resin mortars for chemical fastening.

Furthermore, these known hardener compositions are disadvantageous insofar as they have to contain peroxide amounts of 0.5 wt. % and greater, which is problematic, because peroxide-containing products, starting at a concentration of 1%, for example for dibenzoyl peroxide, have to be labeled as sensitizing in some countries. The same applies to the aminic accelerators, which are sometimes also subject to labeling.

Until now, a few attempts have been made to reduce the amount of peroxide in such a way that it falls below the labeling limit, or to do without the use of peroxides as radical initiators.

DE 102010051818 B3 discloses compositions for chemical fastening, the peroxide quantity of which was reduced. A disadvantage of these compositions is that the load values achievable therewith are not particularly high.

DE 102011078785 A1 describes compositions for chemical fastening which use a peroxide-free hardener system based on 1,3-dioxo compounds as hardeners and a manganese compound as a co-initiator. Although peroxides can be dispensed with, these compositions have the disadvantage that they exhibit a high temperature dependence during hardening. Although the hardener system leads to good curing of the compositions at room temperature and at elevated temperatures, the hardening reaction at low temperatures is too slow or comes to a complete halt, so that the curing is insufficient or is totally lacking.

Compositions for chemical fastening, which likewise dispense with peroxides as initiators, are known from EP 3313896 A1, EP 3775017 A1 and WO 22/002567 A1.

EP 3313896 A1 describes a hardener system for a synthetic resin composition with radically polymerizable compounds which contain an activator in the form of a metal salt and a radical starter of at least one aldehyde and/or ketone and at least one primary amine, and/or at least one aldimine or at least one ketimine, or a mixture of two or more of the constituents. This system should be able to formulate a label-free composition. However, the performance thereof is limited and the curing is highly temperature-dependent, the processing time of the compositions being very short at higher application temperatures, and the curing time being very long at low application temperatures.

EP 3775017 A1 describes the use of compounds known as inhibitors for the radical polymerization, such as phenols, and of triphenyl phosphite, triphenylphosphine, p-toluenesulphonic acid, n-isopropyl-N′-phenyl-phenylenediamine and NH-acidic compounds, in combination with a hardener system which comprises an aldehyde and/or ketone and a primary amine, an aldimine or a ketimine, or a mixture thereof, and a further activator (accelerator) in the form of a metal salt, as an initiator system for a synthetic resin composition containing radically polymerizable compounds. This is intended to accelerate the radical polymerization and improve through-hardening, in particular at low temperatures.

WO 22/002567 A1 describes a specific type of imines which are suitable as part of a hardening system for radically polymerizable reactive resins and/or for reactive resins curable by polyaddition. These imines are obtainable by reaction of an amino-functionalized polyoxyalkylene—the polyoxyalkylene chains of which are a copolymer made up of oxyethylene and oxypropylene units, wherein these polyoxyalkylene chains carry primary amino groups—and a ketone and/or aldehyde with a hydrogen atom at the carbon atom in α-position with respect to the carbonyl carbon. This is intended to obtain increased reactivity compared to comparable systems known up to that point and improved bond resistances. In addition, this makes it possible to avoid labeling, as would be required by commercially available imines and those compounds known from EP 3313896 A1 and EP 3775017 A1.

However, as shown by experiments, the synthetic resin compositions known from EP 3313896 A1, EP 3775017 A1 and WO 22/002567 A1 have the disadvantage that their achievable load level is limited without further adaptation of the composition, because the adhesion of the cured mortar composition to the borehole wall is not optimal. This is shown by the failure profile in pull-out tests, with which the fastening system made up of an anchor rod and mortar composition could be pulled out of the borehole. Thus, additional measures are required, such as the addition of further compounds, which further increases the complexity of the system.

There is therefore a need for a hardener system for reactive resin systems based on radically polymerizable compounds for use as reaction resin mortars, in particular for chemical fastening, which does not have the disadvantages of the known hardener systems and which, however, does not negatively influence the positive properties of the reactive resin mortars.

More precisely, there is a need for a hardener system for reactive resin systems based on radically polymerizable compounds for chemical fastening, with which mortars can be provided, which are label-free, the curing of which is less temperature-dependent than the known hardener systems and with which a better bonding of the cured mortar compositions to the substrate and thus a higher load level of a fastening arrangement can be achieved.

The object of the present invention is now to provide a hardener system for a reactive resin system based on radically polymerizable compounds for use in reactive resin mortars for the chemical fastening of anchoring means which dispenses with the use of peroxides, peresters, perketals or hydroperoxides, and therefore is labeled less critically, thereby enabling the formulation of label-free products, and nevertheless has the advantageous properties of the peroxide-containing hardener systems from the prior art, such as achieving a high load level and a largely temperature-independent curing.

This object is achieved by providing a hardener system which contains an enamine with a metal-based activator and is free of peroxides, peresters, perketals and hydroperoxides.

Surprisingly, it has been found that by using condensation products from secondary amines with aldehydes or ketones, the enamines together with a metal-based activator, hardener systems can be formulated which can be used as hardeners for radically hardening resins, as are used in chemical dowels. The peroxides used to date, which, among other things, lead to the labeling of the mortar compositions, can thus be replaced by label-free compounds, without having to dispense with the advantageous properties of the peroxides, such as use within a wide temperature range.

By dispensing with the use of peroxides, peresters, perketals or hydroperoxides, the hardener systems according to the invention have a number of further advantages compared to the systems known from the prior art. For example, there are no safety-relevant limitations with respect to transport and storage of the components, in particular no labeling as oxidizing. Furthermore, it is possible to dispense with the use of phlegmatizers, which as plasticizers influence the mechanical performance of the cured reaction resins. In addition, less limitations with regard to the further recipe components have to be taken into account in the formulation of multi-component reaction resin compositions.

Compared to the peroxide-free systems known from the prior art, the hardener systems according to the invention have the advantage that they have a better bonding of the cured mortar compositions to the substrate without having to introduce further compounds into the composition, whereby the composition becomes less complex.

A first subject matter of the invention is a hardener system according to claim 1. A second subject matter of the invention is the use of the hardener system according to the invention as an initiator system for a reactive resin system based on radically polymerizable compounds according to claim 11. A third subject matter of the invention is a reactive resin system which contains a radically polymerizable compound as a reactive resin and the hardener system according to the invention, according to claim 13. A fourth subject matter of the invention is a multi-component reactive resin system comprising a resin component and a hardener component according to claim 16. A fifth subject matter of the invention is the use of a reactive resin system according to the invention or of a multi-component reactive resin system according to the invention as an adhesive, coating material or molding compound according to claim 18. A sixth subject matter of the invention is the use of a reactive resin system according to the invention or of a multi-component reactive resin system according to the invention for fastening anchoring means in substrates according to claim 19.

Within the meaning of the invention:
“inhibitor” means a substance which suppresses unwanted radical polymerization during the synthesis or storage of a resin or a resin-containing composition (these substances are also referred to in the art as “stabilizers”), or which delays radical polymerization of a resin (usually in conjunction with an accelerator or activator) after an initiator has been added (these substances are also referred to in the art as “inhibitors”; the particular meaning of the term becomes clear from the context);
“initiator,” “hardener” or “hardening agent” means a substance which (usually in combination with an accelerator) forms reaction-initiating radicals;
“activator” means a substance which reacts with the initiator so that larger quantities of radicals are prepared by the initiator even at low temperatures, or which catalyzes the decomposition reaction of the initiator;
“co-activator” means a substance whose presence enhances the reaction of the hardener with the activator.
“hardener system,” means a combination of the actual hardening agent (initiator) and activator and in some cases a further activator (co-activator);
“hardener component” means a liquid or viscous mixture of the hardening agent, optionally further components, e.g., co-activator, fillers, additives; typically, the hardener composition is one of the two components of a two-component reactive resin system for chemical fastening (in a multi-component system also referred to as a “hardener composition”);
“peroxide-free” means that no peroxides, peresters, perketals, or hydroperoxides are added;
“reactive resin” means a usually solid or high-viscosity “radically polymerizable,” i.e., curable, compound, which cures by means of polymerization and forms a resin matrix; the reactive resin is the reaction product of a bulk reaction per se; this also includes the reaction batch for producing the backbone resin after the reaction has ended, which backbone resin is present without the product being isolated and therefore can contain the reactive resin, a reactive diluent, a stabilizer and a catalyst, if used, in addition to the radically polymerizable compound;
“reactive diluents” means liquid or low-viscosity monomers and backbone resins which dilute other backbone resins or the reactive resin master batch and thereby impart the viscosity necessary for application thereof, which contain functional groups capable of reacting with the reactive resin, and which for the most part become a constituent of the hardened composition (e.g., of the mortar) during polymerization (hardening); reactive diluents are also referred to as co-polymerizable monomers;
“reactive resin mixture” means a liquid mixture of reactive resin, reactive diluents and optionally further components, such as activator and inhibitors, which mixture is formulated by addition of fillers and further additives, for example rheological aids to the reactive resin component.
“reactive resin component means a liquid or viscous mixture of reactive resin, fillers, optionally at least one reactive diluent and optionally further components, for example additives such as rheological additives, adhesion promoters, activators and/or inhibitors; typically, the reactive resin component is one of the two components of a two-component reactive resin system for chemical fastening (also referred to as “reactive resin composition”);
“reactive resin system” means a liquid or viscous mixture of reactive resin, optionally at least one reactive diluent, fillers and optionally further components, as described for the reactive resin composition. In addition, the reactive resin system contains the hardener, in some cases at least one reactive or non-reactive diluent, and also fillers and additives, such as rheological additives, adhesion promoters, (co-)activators and/or inhibitors.
“two-component reactive resin system” means a reactive resin system comprising two separately stored components, a reactive resin component (A) and a hardener component (B), so that a hardening of the backbone resin contained in the reactive resin component takes place after the mixing of the two components;
“multi-component system” or “multi-component reactive resin system” means a reactive resin system comprising a plurality of separately stored components, including a reactive resin component (A) and a hardener component (B), so that the reactive resin contained in the reactive resin component is hardened only after all of the components are mixed;
“(meth)acryl . . . / . . . (meth)acryl . . . ” means both the “methacryl . . . / . . . methacryl . . . ” and the “acryl . . . / . . . acryl . . . ” compounds; “methacryl . . . / . . . methacryl . . . ” compounds are preferred in the present invention;
“epoxy (meth)acrylate” means a compound which has acrylate or methacrylate groups and is substantially free of epoxy groups;
“alkyl” means a saturated hydrocarbon functional group that can be branched or unbranched; preferably a C₁-C₇ alkyl, particularly preferably a C₁-C₄ alkyl, i.e., an alkyl selected from the group consisting of methyl, ethyl, n-propyl, iso-propyl, n-butyl, iso-butyl, and tert-butyl; methyl, ethyl and tert-butyl are particularly preferred and methyl is very particularly preferred;
“hydroxyalkyl” means an alkyl carrying at least one hydroxyl group as a substituent;
“alkenyl” means an unsaturated hydrocarbon functional group having at least one double bond, which can be branched or unbranched; preferably a C₂-C₂₀ alkenyl, particularly preferably a C₂-C₆ alkenyl; i.e., an alkenyl selected from the group consisting of ethenyl, propenyl, butenyl, pentenyl and hexenyl; ethenyl, propenyl and butenyl are particularly preferred, and ethenyl is very particularly preferred;
“cold curing” means that a reactive resin system can cure completely at room temperature;
“a” or “an” as the article preceding a class of chemical compounds, e.g., preceding the word “enamine,” means that one or more compounds included in this class of chemical compounds, e.g., various enamines, may be meant. In a preferred embodiment, this article means only a single compound;
“at least one” means numerically “one or more.” In a preferred embodiment, the term numerically means “one”;
“contain”, “comprise” and “include” mean that further constituents may be present in addition to those mentioned. These terms are intended to be inclusive and therefore also encompass “consist of.” “Consist of” is intended to be exclusive and means that no further constituents may be present. In a preferred embodiment, the terms “contain”, “comprise” and “include” mean the term “consist of”;
“approximately” or “approx.” before a numerical value means a range of ±10% of this value, preferably ±2% of this value, more preferably ±1% of this value, particularly preferably ±0% of this value (i.e., exactly this value).

All standards cited in this text (e.g., DIN standards) were used in the version that was current on the filing date of this application.

### Hardener System

A first subject matter of the invention is a hardener system for a reactive resin system which contains radically polymerizable compounds, wherein the hardener system comprises
a) a compound of formula (I)

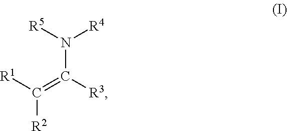

wherein
   R¹, R² and R³ are, each independently of the other, a hydrogen atom, a linear or branched alkyl, linear or branched alkenyl, linear or branched alkylene, cycloalkyl, cycloalkenyl or ar(alk)yl group, wherein the cycloalkyl, cycloalkenyl and ar(alk)yl group may in some cases contain at least one heteroatom and/or may be substituted,
   R⁴ and R⁵ are, each independently of the other, a linear or branched alkyl, linear or branched alkenyl, linear or branched alkylene, cycloalkyl, cycloalkenyl or ar(alk)yl group, wherein the cycloalkyl, cycloalkenyl and ar(alk)yl group each may contain at least one heteroatom and/or may be substituted, or
   R¹ and R², R¹ and R³, R² and R³ and R⁴ and R⁵ together form, each independently of the other, a cycloalkylene or cycloalkenyl group, which may each also contain heteroatoms in or on the ring and/or may be substituted,
and
b) a transition metal in the form of a salt or a complex.

The compound of formula (I) is an enamine

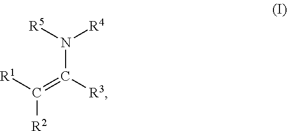

wherein
   R¹, R² and R³ are, each independently of the other, a hydrogen atom, a linear or branched alkyl, linear or branched alkenyl, linear or branched alkylene, cycloalkyl, cycloalkenyl or ar(alk)yl group, wherein the cycloalkyl, cycloalkenyl and ar(alk)yl group may in some cases contain at least one heteroatom and/or may be substituted,
   R⁴ and R⁵ are, each independently of the other, a linear or branched alkyl, linear or branched alkenyl, linear or branched alkylene, cycloalkyl, cycloalkenyl or ar(alk)yl group, wherein the cycloalkyl, cycloalkenyl and ar(alk)yl group each may contain at least one heteroatom and/or may be substituted, or
   R¹ and R², R¹ and R³, R² and R³ and R⁴ and R⁵ together, each independently of the other, form a cycloalkylene or cycloalkenyl group, which can each also contain heteroatoms in or on the ring and/or may be substituted.

R¹, R² and R³ are, each independently of the other, a hydrogen atom, a linear or branched alkyl, linear or branched alkenyl, linear or branched alkylene, cycloalkyl, cycloalkenyl or ar(alk)yl group, wherein the cycloalkyl, cycloalkenyl and ar(alk)yl group may in some cases contain at least one heteroatom and/or may be substituted.

Preferably R¹ and R² are, independently of one another, a linear or branched alkyl group, more preferably a C₁-C₁₀-alkyl group, even more preferably a C₁-C₆-alkyl group, and most preferably a C₁-C₃-alkyl group. Very particularly preferably, R¹ is a methyl or ethyl group and R² a methyl, ethyl or propyl group.

Preferably, R³ is a hydrogen atom, a linear or branched alkyl group, more preferably a hydrogen atom or a linear or branched C₁-C₆-alkyl group, and very particularly preferably a hydrogen atom.

Alternatively, R¹ and R², R¹ and R³ and R² and R³ together form a cycloalkylene or cycloalkenyl group which may also contain at least one heteroatom and/or may be substituted, wherein two or more heteroatoms which may be the same or different and may preferably be selected from oxygen (O), nitrogen (N) and sulfur atoms(S), more preferably under oxygen (O) and nitrogen atoms (N). The cycloalkenyl or cycloalkenyl group may be substituted. The heteroatoms may be contained in or as a substituent on the ring.

R⁴ and R⁵ are, each independently of the other, a linear or branched alkyl, linear or branched alkenyl, linear or branched alkylene, cycloalkyl, cycloalkenyl or ar(alk)yl group, wherein the cycloalkyl, cycloalkenyl and ar(alk)yl group may each contain at least one heteroatom and/or may be substituted.

Alternatively, R⁴ and R⁵ together form a cycloalkylene or cycloalkenyl group which may also contain at least one heteroatom. If two or more heteroatoms are present, the heteroatoms may be the same or different and may preferably be selected from oxygen (O), nitrogen (N) and sulfur atoms(S), more preferably oxygen (O) and nitrogen atoms (N). The cycloalkenyl or cycloalkenyl group may be substituted. The heteroatoms may be contained in or as a substituent on the ring.

Preferably, R⁴ and R⁵ together form an alkylene or cycloalkylene group which also contains at least one heteroatom, preferably one or two heteroatoms, further preferably a cycloalkylene group having two heteroatoms, more preferably a C₅-C₈-cycloalkylene group having two heteroatoms, even more preferably a C₅-C₆-cycloalkylene group having one heteroatom or two heteroatoms, and most preferably a C₅-cycloalkenyl group having two heteroatoms, wherein the heteroatoms are nitrogen atoms (N).

In a preferred embodiment, R¹, R² and R³ are, independently of one another, a hydrogen atom, a linear or branched alkyl, cycloalkyl, linear or branched alkenyl, linear or branched alkylene, cycloalkenyl or aryl group, each of which may in some cases be substituted, and R⁴ and R⁵ together an alkylene or cycloalkylene unit which also comprises at least one heteroatom, preferably one or two heteroatoms.

In a further preferred embodiment, R¹, R² and R³ are, independently of one another, a hydrogen atom, a linear or branched alkyl group, more preferably a C₁-C₁₀-alkyl group, even more preferably a C₁-C₆-alkyl group, and R⁴ and R⁵ together form a C₅-C₈-cycloalkylene unit having two heteroatoms, even more preferably a C₅-C₆-cycloalkylene unit having one heteroatom or two heteroatoms.

In a still further preferred embodiment, R¹ and R² are, independently of one another, a linear or branched alkyl group, more preferably a C₁-C₁₀-alkyl group, even more preferably a C₁-C₆-alkyl group, R³ is a hydrogen atom and R⁴ and R⁵ together a C₅-C₈-cycloalkylene unit having two heteroatoms, even more preferably a C₅-C₆-cycloalkylene unit having one heteroatom or two heteroatoms.

In a particularly preferred embodiment, R¹ and R² are, independently of one another, a C₁-C₃-alkyl group, very particularly preferably in each case a methyl group, R³ is a hydrogen atom and R⁴ and R⁵ together form a cycloalkylene unit which carries a nitrogen atom (N) and in some cases a further nitrogen atom and/or oxygen atom (O) as heteroatoms.

In a very particularly preferred embodiment, in the compound of the formula (I) R¹ and R² are a methyl, ethyl or propyl group, R³ is a hydrogen atom and R⁴ and R⁵ form a 5-member heterocycle having a nitrogen atom or a 6-member heterocycle having an oxygen atom and a nitrogen atom or having two nitrogen atoms as heteroatoms, in particular a pyrrolidine, piperidine-, piperazine or morpholine radical.

The enamines described are obtainable by condensation reaction of an aldehyde or a ketone that carries a hydrogen atom on the carbon atom in the α position to the carbonyl carbon, with an amine comprising at least one secondary amino group.

The aldehydes or ketones which can be used are in particular those of formula (II)

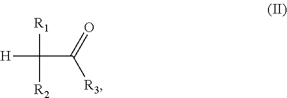

where:
   R¹, R² and R³ have the meaning as described above for formula (I).

Preferably, the aldehydes and/or ketones are compounds which have at least one or more (primary and/or secondary) hydrogen atoms on the α carbon atom belonging to the carbonyl group. Examples of such aldehydes are acetaldehyde, propanal (propionaldehyde), 2-methylpropanal (isobutyraldehyde), 2,2-dimethylpropanal (pivalaldehyde, trimethylacetaldehyde), butanal, 2-methylbutanal (2-methylbutyraldehyde) 2-ethylbutanal, n-pentanal (valeraldehyde), iso-pentanal (isovaleraldehyde), 2-methylpentanal, 3-methylpentanal, 4-methylpentanal, 2,3-dimethylpentanal, hexanal, 2-ethylhexanal, heptanal, octanal, nonanal, decanal, undecanal, 2-methylundecanal, dodecanal, or methoxyacetaldehyde, or 3,7-dimethyl-6-octenal (citronellal), malondialdehyde (propanedial), succinaldehyde (butanedial), glutardialdehyde (pentanedial), adipaldehyde (hexanedial) or 3,7-dimethyl-7-hydroxyoctanal (hydroxycitronellal).

The aldehydes and/or ketones are further preferably compounds which have a branching and/or a double bond on the α carbon atom belonging to the carbonyl group. As a result, the further preferred aldehydes and/or ketones only have a (tertiary) hydrogen atom on the α carbon atom belonging to the carbonyl group. Examples of particularly preferred aldehydes are isobutyraldehyde, 2-ethylhexanal, 2-methylbutanal, 2-ethylbutanal, 2-methylvaleraldehyde, 2,3-dimethylvaleraldehyde, 2,6-dimethyl-5-heptenal, cyclopentanecarbaldehyde, 2-methylcyclopentanone 4-formyl tetrahydropyrane, 2-phenyl-propionaldehyd or 3,7-dimethyl-2,6-octadienal (citral), 3-(4-tert-butylphenyl)-2-methylpropanal (Lilial, lysmeral), tetrahydrofurane-3-carboxaldehyde, tetrahydro-2-furane carboxaldehyde, 4-formyl tetrahydropyrane, tetrahydro-2H-pyrane-2-carbaldehyde or tetrahydro-pyrane-3-carbaldehyde. Examples of further preferred ketones include diisopropyl ketone, 3-methyl-2-pentanone, 2-methylcyclohexanone or ionone.

Aldehydes with branching at the carbonyl group a carbon atom are particularly preferred.

More preferably, these are aldehydes with a branching and a hydrogen atom on the α-carbon for the carbonyl group.

The aldehydes mentioned in the examples and mixtures of two or more thereof are also particularly preferred.

Very particular preference is given to isobutyraldehyde, 2-methylbutanal, 2-ethylbutanal and 2-methylpentanal.

The usable or suitable secondary amines are in particular those of the formula (III)

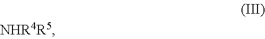

wherein
   R⁴ and R⁵ have the meaning as described above for formula (I).

Preferably, R⁴ and R⁵ together form an alkylene or cycloalkylene group, which also comprises at least one heteroatom, preferably one or two heteroatoms, more preferably a cycloalkylene group having two heteroatoms, more preferably a C₅-C₈-cycloalkylene unit having two heteroatoms, even more preferably a C₅-C₆-cycloalkylene unit having one heteroatom or two heteroatoms, and most preferably a C₅-cycloalkenyl group having two heteroatoms, wherein the heteroatoms are nitrogen atoms (N).

Suitable secondary amines are, for example, 2-methylpyrrolidine, 2,5-dimethylpyrrolidine, piperidine, 4-(1-pyrrolidinyl)-piperidine, piperazine, 1-methylpiperazine, 2,5- and 2,6-dimethylpiperazine, 2,3,5,6-tetramethylpiperazine, 1-(2-methoxyethyl)-piperazine, pyrrolidine, morpholine, thiomorpholine, 3-phenylthiomorpholine, dimethylamine, diethylamine, di-n-propylamine, diisopropylamine, di-n-butylamine, di-iso-butylamine, di-tert.-butylamine, diethanolamine, and the like, N-benzylmethylamine, dibenzylamine, N,N′-dimethylethylendiamine, N,N′-dimethyl-diethylentriamine, N,N′-diisopropylethylendiamine, N,N′-dibutylethylendiamine, N,N′-dimethyl-dipropylentriamine, N,N-bis-[3-(methylamino)-propyl]-methylamine, N,N′-di-tert.-butylethylendiamine, tris[2-(methylamino)-ethyl]-amine, N,N,N′-trimethylethylendiamine, N,N-dimethyl-N′-ethylethylendiamine, N,N′-dimethyl-1,6-hexandiamine, N,N-diethyl-2-(1-piperazinyl) ethanamine, and homologs of the piperazine, like 1,4,7-triazacyclononane, 1,4,7,10-tetraazacyclododecane, 1,4,8,11-tetraazacyclotetradecane, or 1,7-dioxa-4,10-diazacyclododecane.

Also preferred are the amines mentioned in the examples or mixtures of two or more thereof.

The initiation of the polymerization and thus the hardening of the reactive resins is based on a reaction of the at least one enamine with an activator. Suitable activators are transition metals in the form of salts and compounds, which also includes oxides and complexes.

In the case of the transition metals in the form of a metal salt, which also includes metal complexes and metal oxides, these are preferably one or more metal salts or in particular one or more salts of organic and/or inorganic acids with metals, for example selected from copper, iron, vanadium, manganese, cerium, cobalt, zirconium or bismuth, or mixtures of two or more thereof. In particular, the metal salts are selected from the group consisting of vanadium, iron, manganese and copper, in particular in the form of salts or complexes with inorganic acid residues, such as sulfate and/or carbonate residues and/or organic acid residues, for example carboxylate residues, wherein the organic acids are straight-chain or branched and preferably saturated, such as carboxylates with CH₃, C₂-C₂₀-alkyl, a C₆-C₂₄-aryl radical or C₇-C₃₀-aralkyl radical, for example octoate, for example 2-ethylhexanoate (isooctanoate), neodecanoate, or acetylacetonate. Particular preference is given to salts which are soluble in organic media, such as carboxylates, for example octanoates, naphthenates, acetylacetonates, acetates and quinolates. Manganese, vanadium, cobalt and copper carboxylates are very particularly preferred.

The transition metals are reactively different. Reactivity depends on different factors, such as the oxidation potential thereof, the salts and compounds used, in some cases also on the form in which the transition metals are present, for example in solutions, wherein the solvent can also influence the reactivity. When using less reactive transition metal salts and compounds which have a lower activity, such as, for example, iron and copper salts and compounds, a further activator (co-activator) is required, so that the initiator system has sufficient activity in order to be able to initiate the radical polymerization under construction site conditions.

Under conditions as are prevalent in the use of reactive resins as mortar for chemical fastening, in particular in the basic environment and at very different or fluctuating temperatures, the enamines in combination with an activator alone are not reactive enough. Therefore, these are activated by adding a co-activator.

For the hardener system according to the invention, in particular when copper is used as activator, phenols, such as butylhydroxytoluene, hydroquinone, pyrocatechol and their alkylated or etherified derivatives (e.g., tert-butylpyrocatechol or hydroquinone monomethyl ether), phosphites such as triethyl or triphenyl phosphate), phthalimide, saccharin and the like, are suitable coactivators for the enamine-based hardener system according to the invention.

Preferably, saccharin can be used as a co-activator.

Conceivable also as a co-activation in some cases are the amines typically used in fastening systems, for example dimethylamine, trimethylamine, diethylamine, triethylamine, di-n-propylamine, tri-n-propylamine, diisopropylamine, triisopropylamine, di-n-butylamine, diisobutylamine, tri-isobutylamine, diisopentylamine, diethanolamine, triethanolamine, dimethyl(2-chloroethyl)amine, bis(2-chloroethyl)amine, bis(2-ethylhexyl)amine, N-methylstearylamine, dialkylamine, N,N′-dimethylethylendiamine, permethyldiethylentriamine, trimethylhexamethylendiamine, N,N-dimethylaminoethanol, 2-(2-diethylaminoethoxy)ethanol, tris-[2-(2-hydroxy-ethoxy)-ethyl]amine, 3-dimethylamino-1-propanol, 1-diethylamino-2-propanol, diisopropanolamine, methyl-bis(2-hydroxypropyl)amine, tris(2-hydroxypropyl)amine, 5-diethylamino-2-pentanone, 3-methylaminopropionic acid nitrile, N-methylcyclohexylamine, N,N-dimethylcyclohexylamine, dicyclohexylamine, N-ethylcyclohexylamine, N-(2-hydroxyethyl)-cyclohexylamine, N,N-bis-(2-hydroxyethyl)-cyclohexylamine, N-methylaniline, N,N-dimethylaniline, N,N-diethylaniline, N,N-di-propylaniline, diphenylamine, N-hydroxyethylaniline, Bis(N-hydroxyethyl) aniline, dibenzylamine, tribenzylamine, methyldibenzylamine, N,N-diisopropylaniline, N-dodecylaniline, N-methylaminonaphthaline, N,N-dimethylaminonaphthaline, N,N-dibenzylnaphthaline, morpholine, N-methylmorpholine, N-phenylmorpholine, hydroxyethylmorpholine, N-methylpyrrolidine, pyrrolidine, piperidine, hydroxyethylpiperidine, pyrroles, pyridines, quinolines, indoles, indolenines, carbazoles, pyrazoles, imidazoles, thiazoles, pyrimidine, quinoxaline, dimorpholinethane, [2,2,2]-diazabicyclooctane and N,N-dimethyl-p-toluidine.

It has been shown that for the purposes of chemical fastening, in particular for the chemical fastening of anchoring means in boreholes, by means of radically hardening mortar systems, a hardener system based on copper in the form of salts and compounds, in particular carboxylates, enamine and saccharin is very particularly preferred, because with them, compared to hardener systems which contain other, more reactive metals, in particular vanadium and cobalt, compositions can be provided which are storage-stable.

The hardener system according to the invention contains the enamine in an amount of 30 to 99.9 wt. %, preferably 40 to 99 wt. %, particularly preferably 40 to 95 wt. % and very particularly preferably 50 to 95 wt. %, in each case based on the total weight of the hardener system.

If the hardener system contains a metal-based activator, it is contained in an amount of from 0.001 to 50 wt. %, preferably from 0.05 to 50 wt. %, and particularly preferably from 0.3 to 40 wt. %, in each case based on the total weight, of the hardener system.

If the hardener system contains a co-activator, for example, saccharin, it is contained in an amount of 0.01 to 50 wt. %, preferably 0.1 to 40 wt. % and particularly preferably 0.1 to 30 wt. %, in each case based on the total weight of the hardener system.

The hardener system according to the invention is suitable as an initiator for the radical polymerization and thus for the hardening of reactive resin systems based on radically hardening compounds, so-called reactive resins.

The hardener system according to the invention makes it possible to provide a reactive resin system which, in addition to the hardener system according to the invention, contains a reactive resin and can further contain additives and fillers as further constituents and which is peroxide-free and thus makes labeling less critical, and in the best case no longer necessary. This reactive resin system is particularly suitable for chemical fastening, in particular the chemical fastening of anchoring means in boreholes, because they enable higher load values, also in wet boreholes.

Therefore, a further subject matter of the invention is the use of the hardener system according to the invention as a peroxide-free initiator system for a reactive resin system with radically polymerizable compounds, in particular for chemical fastening.

### Reactive Resin System

Furthermore, a further subject matter of the invention is a reactive resin system which contains the hardener system according to the invention, at least one radically polymerizable compound, at least one reactive diluent and in some cases organic and/or inorganic additives and also fillers.

The reactive resin system preferably includes the at least one activator dissolved or dispersed in the reactive resin and in some cases at least one co-activator of the hardener system. Suitable activators and co-activators are described above as constituents of the hardener system.

In the hardener system, the reactive resin system contains the enamine in an amount of 0.1 to 30 wt. %, preferably 0.2 to 25 wt. %, particularly preferably 0.5 to 25 wt. % and very particularly preferably 0.5 to 20 wt. %, in each case based on the total weight of the reactive resin system.

If the reactive resin system comprises a metal-based activator, it is contained in an amount of from 0.001 to 10 wt. %, preferably from 0.005 to 5 wt. % and particularly preferably from 0.01 to 2 wt. %, in each case based on the total weight of the reactive resin system.

If the reactive resin system contains a co-activator, for example saccharin, it is contained in an amount of from 0.001 to 10 wt. %, preferably from 0.05 to 10 wt. %, and particularly preferably from 0.01 to 3 wt. %, in each case based on the total weight of the reactive resin system.

The reactive resin system comprises at least one radically polymerizable compound as reactive resin.

Compounds based on urethane(meth)acrylate-based compounds, compounds based on epoxy(meth)acrylate compounds, methacrylates of alkoxylated bisphenols, compounds based on further ethylenically unsaturated compounds and combinations thereof are suitable as radically polymerizable compounds for the reactive resin, as is known to a person skilled in the art.

Particularly suitable and preferred vinyl ester resins are (meth)acrylate-functionalized resins, which are obtained, for example, by reacting di- and/or higher-functional isocyanates with suitable acrylic compounds, in some cases with the help of hydroxy compounds that contain at least two hydroxyl groups, as described for example in DE 3940309 A1. Very particularly suitable and preferred are the urethane methacrylate resins (which are also referred to as vinyl ester urethane resins) described in DE 102011017 626 B4.

Aliphatic (cyclic or linear) and/or aromatic di- or higher-functional isocyanates or prepolymers thereof can be used as isocyanates. The use of such compounds increases wettability and thus improves the adhesive properties. Aromatic di- or higher-functional isocyanates or prepolymers thereof are preferred, with aromatic di- or higher-functional prepolymers being particularly preferred. Toluylene diisocyanate (TDI), diisocyanatodiphenylmethane (MDI) and polymeric diisocyanatodiphenylmethane (pMDI) for increasing chain stiffening, and hexane diisocyanate (HDI) and isophorone diisocyanate (IPDI), which improve flexibility, may be mentioned by way of example, of which polymeric diisocyanatodiphenylmethane (pMDI) is very particularly preferred.

Suitable acrylic compounds are acrylic acid and acrylic acids substituted on the hydrocarbon group, such as methacrylic acid, hydroxyl-group-containing esters of acrylic or methacrylic acid with polyhydric alcohols, pentaerythritol tri(meth)acrylate, glycerol di(meth)acrylate, such as trimethylolpropane di(meth)acrylate and neopentyl glycol mono(meth)acrylate. Acrylic or methacrylic acid hydroxyalkyl esters, such as hydroxyethyl(meth)acrylate, hydroxypropyl(meth)acrylate, polyoxyethylene(meth)acrylate, polyoxypropylene(meth)-acrylate. Particular preference is given here to the corresponding methacrylates, because the steric hindrance of acrylates leads to improved alkali stability.

Also suitable are compounds which are based at least in part on a recycled compound, in particular of (meth)acrylic esters. Particular preference is given to a (meth)acrylic ester which is obtained from recycled methyl (meth)acrylate. Suitable compounds include hydroxyl-group-containing esters of acrylic or methacrylic acid with polyhydric alcohols, pentaerythritol tri(meth)acrylate, glycerol di(meth)acrylate, such as trimethylolpropane di(meth)acrylate, and neopentyl glycol mono(meth)acrylate, preferably acrylic or methacrylic acid hydroxyalkyl esters, such as hydroxyethyl(meth)acrylate, hydroxypropyl(meth)acrylate, polyoxyethylene(meth)acrylate and polyoxypropylene(meth)acrylate, each of which can be obtained from recycled methyl(meth)acrylate.

Hydroxy compounds that can optionally be used are suitable dihydric or higher alcohols, for example secondary products of ethylene oxide or propylene oxide, such as ethanediol, di- or triethylene glycol, propanediol, dipropylene glycol, other diols, such as 1,4-butanediol, 1,6-hexanediol, neopentyl glycol, diethanolamine, further bisphenol A or F or their ethoxylation/propoxylation and/or hydrogenation or halogenation products, higher alcohols, such as glycerol, trimethylolpropane, hexanetriol and pentaerythritol, hydroxyl-group-containing polyethers, for example oligomers of aliphatic or aromatic oxiranes and/or higher cyclic ethers, such as ethylene oxide, propylene oxide, styrene oxide and furan, polyethers which contain aromatic structural units in the main chain, such as those of bisphenol A or F, hydroxyl-group-containing polyesters based on the above-mentioned alcohols or polyethers and dicarboxylic acids or their anhydrides, such as adipic acid, phthalic acid, tetra- or hexahydrophthalic acid, HET acid, maleic acid, fumaric acid, itaconic acid, sebacic acid and the like. Particularly preferred are hydroxy compounds having aromatic structural units to reinforce the chain of the resin, hydroxy compounds containing unsaturated structural units, such as fumaric acid, to increase the crosslinking density, branched or star-shaped hydroxy compounds, in particular trihydric or higher valence alcohols and/or polyethers or polyesters containing the structural units thereof, branched or star-shaped urethane (meth)acrylates to achieve lower viscosity of the resins or the solutions thereof in reactive diluents and higher reactivity and crosslinking density.

The vinyl ester resin preferably has a molecular weight Mn in the range from 500 to 3,000 daltons, more preferably 500 to 1,500 daltons (according to ISO 13885-1). The vinyl ester resin has an acid value in the range of 0 to 50 mg KOH/g resin, preferably in the range of 0 to 30 mg KOH/g resin (according to ISO 2114-2000).

Preferred vinyl ester resins are (meth)acrylate-functionalized resins and resins which are obtained by reacting an epoxy oligomer or epoxy polymer with methacrylic acid or methacrylamide, preferably with methacrylic acid, and in some cases with a chain extender, such as diethylene glycol or dipropylene glycol. Examples of compounds of this kind are known from the applications U.S. Pat. Nos. 3,297,745 A, 3,772,404 A, 4,618,658 A, GB 2217722 A1, DE 3744390 A1 and DE 4131457 A1.

The epoxy(meth)acrylate resins are obtained by reacting an organic compound having epoxide groups with acrylic acid or methacrylic acid, so that the resins necessarily have acryloxy groups or methyloxy groups at the molecular ends and hydroxyl groups in the 2 position for the formed acryloxy or methacryloxy group (also referred to below as a hydroxyl groups) in the main chain of the molecule. It is expedient to use 0.7 to 1.2 carboxyl equivalents of (meth)acrylic acid per epoxide equivalent. The organic compounds comprising epoxide groups and the (meth)acrylic acid are preferably used in approximately stoichiometric ratios, i.e., an equivalent (meth)acrylic acid is used per epoxide equivalent of the organic compound, for example. The reaction is carried out in the presence of suitable catalysts known to those skilled in the art, such as quaternary ammonium salts.

Advantageously, organic compounds having epoxide groups are used with a molecular weight having a number average molecular weight Mn in the range from 129 to 2,400 g/mol and which include at least one, preferably 1.5 to 2 epoxy groups per molecule in the average. The epoxy groups are particularly preferably of the glycidyl ether or glycidyl ester type obtained by reacting an epihalohydrin, in particular epichlorohydrin, with a mono- or polyfunctional aliphatic or aromatic hydroxy compounds, thiol compounds or carboxylic acids or a mixture thereof. The organic compound comprising obtained epoxide groups has an epoxy equivalent mass (EEW) preferably in the range from 87 to 1600 g/val, more preferably in the range from 160 to 800 g/val and most preferably in the range from 300 to 600 g/val.

Examples of suitable compounds having epoxide groups are polyglycidyl ethers of polyhydric phenols, for example pyrocatechol, resorcinol, hydroquinone, 4,4′-dihydroxydiphenylmethane, 2,2-(4,4′-dihydroxydiphenyl) propane (bisphenol A), bis(4-hydroxyphenyl) methane (bisphenol F), 4,4′-dihydroxydiphenyl sulfone (bisphenol S), 4,4′-dihydroxydiphenyl cyclohexane, tris(4-hydroxyphenyl)-methane, novolacs (i.e., from reaction products of mono- or polyhydric phenols with aldehydes, in particular formaldehyde, in the presence of acidic catalysts), such as phenol novolac resin, cresol novolac resin.

Furthermore, the following can be mentioned as non-limiting examples: Glycidyl ethers of monoalcohols, for example n-butanol or 2-ethylhexanol; or glycidyl ethers of polyhydric alcohols, for example of 1,3-butanediol, 1,4-butanediol, 1,6-hexanediol, glycerol, benzyl alcohol, neopentyl glycol, ethylene glycol, cyclohexanedimethanol, trimethylolpropane, pentaerythritol and polyethylene glycols, triglycidyl isocyanurate; polyglycidyl thioether of polyvalent thiols, such as bismercaptomethylbenzene; or glycidyl esters of monocarboxylic acids, such as versatic acid; or glycidyl esters of polyvalent, aromatic and aliphatic carboxylic acids, for example phthalic acid diglycidyl esters, isophthalic acid diglycidyl esters, terephthalic acid diglycidyl esters, tetrayhydrophthalic acid diglycidyl esters, adipinic acid diglycidyl esters, and hexahydrophthalic acid diglycidyl esters.

Particularly preferred organic compounds comprising epoxide groups are diglycidyl ethers of divalent hydroxy compounds of the general formula (VI)

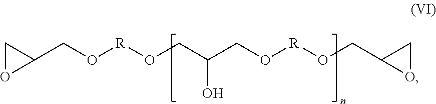

in which R is an unsubstituted or substituted aliphatic or aromatic group, preferably an aromatic group, more preferably an aromatic group having 6 to 24 carbon atoms, and the average value for n is 0 to 3. R is particularly preferably a group of the bisphenol type, such as bisphenol A, bisphenol F or bisphenol S, or of the novolac type, wherein a group of the bisphenol type is very particularly preferred. The average value for n is preferably about 0.1, about 1 or about 2. Within the meaning of the present invention, compounds in which n~0.1 are referred to as monomers, and compounds in which n~1 or 2 are referred to as polymers.

The polymeric compounds have the advantage over the monomeric compounds that the reactive resin content in the reactive resin composition can be significantly reduced, which makes the reactive resin composition more economical in production, because the production costs can thereby be reduced.

Within the meaning of the invention, vinyl ester resins are oligomers or polymers having at least one (meth)acrylate end group, what are referred to as (meth)acrylate-functionalized resins, which also include primarily epoxy (meth)acrylates.

Vinyl ester resins, which have unsaturated groups only in the end position, are obtained, for example, by reacting epoxy oligomers or polymers (for example bisphenol A diglycidyl ether, phenol novolac-type epoxies or epoxy oligomers based on tetrabromobisphenol A) with (meth)acrylic acid or (meth)acrylamide, for example. Preferred vinyl ester resins are (meth)acrylate-functionalized resins and resins which are obtained by reacting epoxy oligomers or epoxy polymers with methacrylic acid or methacrylamide, preferably with methacrylic acid. Examples of compounds of this kind are known from the applications U.S. Pat. Nos. 3,297,745 A, 3,772,404 A, 4,618,658 A, GB 2217722 A1, DE 3744390 A1 and DE 4131457 A1. In this context, reference is made to the application US 2011/071234.

The vinyl ester resin preferably has a molecular weight Mn in the range of 500 to 3,000 daltons, more preferably 500 to 1,500 daltons (according to ISO 13885-1). The vinyl ester resin has an acid value in the range of 0 to 50 mg KOH/g resin, preferably in the range of 0 to 30 mg KOH/g resin (according to ISO 2114-2000).

Ethoxylated bisphenol A di(meth)acrylate having a degree of ethoxylation of 2 to 10, preferably of 2 to 4, difunctional, trifunctional or higher functional urethane (meth)acrylate oligomers, or mixtures of these polymerizable constituents are particularly suitable as the vinyl ester resin.

Examples of epoxy(meth)acrylates of this kind are those of formula (V)

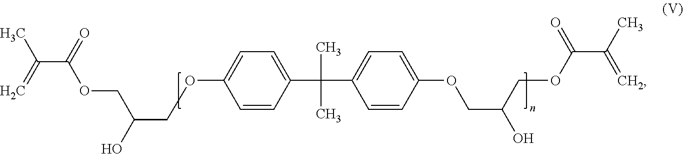

wherein n represents a number greater than or equal to 1 (if mixtures of different molecules are present with different n values and are represented by formula (V), non integers are also possible as an average).

Further examples of the propoxylated or in particular ethoxylated aromatic diol, such as bisphenol A, bisphenol F or novolac (in particular di-)(meth)acrylates, are those of formula (VI)

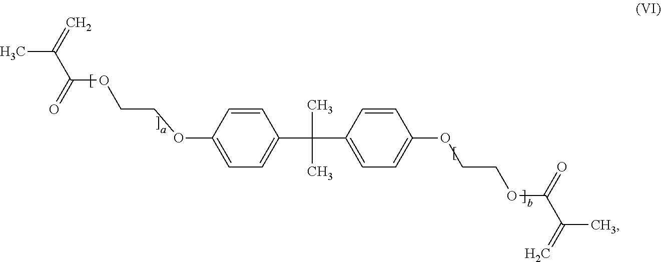

wherein a and b each independently represent a number greater than or equal to 0 with the proviso that preferably at least one of the values is greater than 0, preferably both 1 or greater (if mixtures of different molecules having different (a and b) values are present and are represented by the formula (VI), non-integer numbers are also possible as the average value).

The known reaction products of di- or polyisocyanates and hydroxyalkylmethylacrylates, as described, for example, in DE 2312559 A1, adducts of (di) isocyanates and 2,2-propane bis[3-(4-phenoxy)-1,2-hydroxypropane-1-methacrylate] according to U.S. Pat. No. 3,629,187, and the adducts of isocyanates and methacryloyl alkyl ethers, alkoxybenzenes or alkoxycycloalkanes, as described in EP 44352 A1, are very particularly suitable. In this context, reference is made to DE 2312559 A1, DE 19902685 A1, EP 0684906 A1, DE 4111828 A1 and DE 19961342 A1. Of course, mixtures of suitable monomers can also be used.

All of these resins that can preferably be used according to the invention can be modified according to methods known to a person skilled in the art, for example to achieve lower acid numbers, hydroxide numbers or anhydride numbers, or can be made more flexible by introducing flexible units into the backbone, and the like.

In addition, the reactive resin may contain other reactive groups that can be polymerized with a radical initiator, such as peroxides, for example reactive groups derived from itaconic acid, citraconic acid and allylic groups and the like, as described, for example, in WO 2010/108939 A1 (itaconic acid ester).

The reactive resin system can contain suitable reactive diluents, as are described in the applications EP 1 935 860 A1 and DE 195 31 649 A1. Preferably, the reactive resin composition contains, as the reactive diluents, a (meth)acrylic acid ester, particularly preferably aliphatic or aromatic C₅-C₁₅-(meth)acrylates being selected. Suitable examples comprise: 2-, 3-hydroxypropyl (meth)acrylate (HP (M) A), 1,3-propanediol di(meth)acrylate, 1,3-butanediol di(meth)acrylate, 1,4-butanediol di(meth)acrylate, trimethylolpropane tri(meth)acrylate, phenethyl (meth)acrylate, tetrahydrofurfuryl (meth)acrylate, N,N-dimethylaminoethyl (meth)acrylate, N,N-dimethylaminomethyl (meth)acrylate, acetoacetoxyethyl (meth)acrylate, isobornyl (meth)acrylate, 2-ethylhexyl (meth)acrylate, methoxypolyethylene glycol mono(meth)acrylate, trimethylcyclohexyl (meth)acrylate, 2-hydroxyethyl (meth)acrylate, dicyclopentenyloxyethyl (meth)acrylate and/or tricyclopentadienyl di(meth)acrylate, bisphenol A (meth)acrylate, novolac epoxy di(meth)acrylate, di-[(meth)acryloyl-maleoyl]-tricyclo-5.2.1.0.^{2.6}-decane, dicyclopentenyloxyethylcrotonate, 3-(meth)acryloyl-oxymethyl-tricylo-5.2.1.0.^{2.6}-decane, 3-(meth)cyclopentadienyl (meth)acrylate, and decalyl-2-(meth)acrylate; glycerol formal(meth)acrylate; solketal (meth)acrylate, cyclohexyl (meth)acrylate, phenoxyethyl di(meth)acrylate, methoxyethyl (meth)acrylate, tert-butyl (meth)acrylate and norbornyl (meth)acrylate. Methacrylates are preferred over acrylates. Particularly preferred are 2- and 3-hydroxypropyl methacrylate (HPMA), 1,2-ethanediol dimethacrylate, 1,4-butanediol dimethacrylate (BDDMA), 1,3-butanediol dimethacrylate, trimethylolpropane trimethacrylate, acetoacetoxyethyl methacrylate, isobornyl methacrylate, bisphenol A methacrylate, trimethylcyclohexyl methacrylate, 2-hydroxyethyl methacrylate, PEG200 or PEG400 dimethacrylate and norbornyl methacrylate. 1,4-Butanediol dimethacrylate and a mixture of 2- and 3-hydroxypropyl methacrylate (HPMA), or a mixture of these three methacrylates, are very particularly preferred. A mixture of 2- and 3-hydroxypropyl methacrylate (HPMA) is most preferred. In principle, other conventional radically polymerizable compounds, alone or in a mixture with the (meth)acrylic acid esters, can also be used as reactive diluents, e.g., styrene, α-methylstyrene, alkylated styrenes, such as tert-butylstyrene, divinylbenzene and vinyl and allyl compounds, of which the representatives that are not subject to mandatory labeling are preferred. Examples of vinyl or allyl compounds of this kind are hydroxybutyl vinyl ether, ethylene glycol divinyl ether, 1,4-butanediol divinyl ether, trimethylolpropane divinyl ether, trimethylolpropane trivinyl ether, mono-, di-, tri-, tetra- and polyalkylene glycol vinyl ether, mono-, di-, tri-, tetra- and polyalkylene glycol allyl ether, adipic acid divinyl ester, trimethylolpropane diallyl ether and trimethylolpropane triallyl ether.

The reactive diluents are preferably present in the reactive resin in an amount to approx. 80 wt. %, particularly preferably from approx. 10 to approx. 60 wt. %, even more preferably from approx. 30 to approx. 60 wt. %, based on the reactive resin.

One or more inhibitors can be present in the reactive resin system according to the invention, both for stabilizing the reactive resin or the reactive resin composition containing the reactive resin, and for adjusting the resin reactivity.

The inhibitors usually used for radically polymerizable compounds, as are known to a person skilled in the art, are suitable for this purpose. These inhibitors are preferably selected from non-phenolic inhibitors, in particular phenothiazines.

Phenothiazines such as phenothiazine and/or derivatives or combinations thereof, or stable organic radicals such as galvinoxyl and N-oxyl radicals, in particular of the piperidinyl-N-oxyl or tetrahydropyrrole-N-oxyl type, are preferably considered as non-phenolic inhibitors, such as aluminum-N-nitrosophenylhydroxylamine, diethylhydroxylamine, oximes such as acetaldoxime, acetone oxime, methyl ethyl ketoxime, salicyloxime, benzoxime, glyoximes, dimethylglyoxime, acetone-O-(benzyloxycarbonyl) oxime, 4-hydroxy-TEMPO, (TEMPOL), 4-acetyl-TEMPO, TEMPO and the like.

Furthermore, pyrimidinol or pyridinol compounds substituted in para-position to the hydroxyl group, as described in DE 10 2011 077 248 B1, can be used as inhibitors.

Examples of stable N-oxyl radicals which can be used are those described in DE 199 56 509 A1 and DE 195 31 649 A1. Stable nitroxyl radicals of this kind are of the piperidinyl-N-oxyl or tetrahydropyrrole-N-oxyl type or a mixture thereof.

Preferred stable nitroxyl radicals are selected from the group consisting of 1-oxyl-2,2,6,6-tetramethylpiperidine, 1-oxyl-2,2,6,6-tetramethylpiperidin-4-ol (also referred to as TEMPOL), 1-oxyl-2,2,6,6-tetramethylpiperidin-4-one (also referred to as TEMPON), 1-oxyl-2,2,6,6-tetramethyl-4-carboxyl-piperidine (also referred to as 4-carboxy-TEMPO), 1-oxyl-2,2,5,5-tetramethylpyrrolidine, 1-oxyl-2,2,5,5-tetramethyl-3-carboxylpyrrolidine (also referred to as 3-carboxy-PROXYL) and mixtures of two or more of these compounds, with 1-oxyl-2,2,6,6-tetramethylpiperidin-4-ol (TEMPOL) being particularly preferred.

The inhibitor or inhibitors are preferably selected from the group consisting of N-oxyl radicals, catechols, catechol derivatives and phenothiazines and a mixture of two or more thereof. The inhibitor or inhibitors selected from the group consisting of Tempol, catechols and phenothiazines are particularly preferred. The inhibitors used in the examples are very particularly preferred, preferably approximately in the amounts stated in the examples.

The inhibitors can be used either alone or as a combination of two or more thereof, depending on the desired properties of the reactive resin. The combination of phenolic and non-phenolic inhibitors is preferred.

The inhibitor or inhibitor mixture is added—or is already contained in the raw materials used—in conventional amounts known in the art, preferably in an amount of approximately 0.0005 to approximately 2 wt. %, more preferably from approximately 0.001 to approximately 1 wt. %, even more preferably from approximately 0.005 to approximately 0.5 wt. % based on the reactive resin.

Furthermore, the reactive resin system may contain customary fillers and/or additives for chemical fastening. It should be noted that some substances can be used both as a filler and, optionally in modified form, as an additive. For example, fumed silica is preferably used as a filler in its polar, non-after-treated form, and is preferably used as an additive in its non-polar, after-treated form. In cases in which exactly the same substance can be used as a filler or an additive, its total amount should not exceed the upper limit for fillers that is determined herein.

To formulate the reactive resin system according to the invention, conventional fillers may be used, preferably mineral or mineral-like fillers, such as quartz, glass, sand, quartz sand, quartz powder, porcelain, corundum, ceramics, talc, silica (e.g., fumed silica, in particular polar, non-after-treated fumed silica), silicates, aluminum oxides (e.g., alumina), clay, titanium dioxide, chalk, barite, feldspar, basalt, aluminum hydroxide, granite or sandstone, polymeric fillers such as thermosets, hydraulically curable fillers such as gypsum, quicklime or cement (e.g., aluminate cement (often referred to as alumina cement) or Portland cement), metals such as aluminum, carbon black, and also wood, mineral or organic fibers, or the like, or mixtures of two or more thereof. The fillers may be present in any desired shapes, for example as powder, or as shaped bodies, e.g., having a cylindrical, annular, spherical, platelet, rod, saddle or crystal shapes, or else shaped like fiber (fibrillar fillers), and the corresponding base particles preferably have a maximum diameter of approximately 10 mm and a minimum diameter of approximately 1 nm. This means that the diameter is approximately 10 mm or any value less than approximately 10 mm, but more than approximately 1 nm. The maximum diameter is preferably a diameter of approximately 5 mm, more preferably approximately 3 mm, even more preferably approximately 0.7 mm. A maximum diameter of approximately 0.5 mm is very particularly preferred. The more preferred minimum diameter is approximately 10 nm, even more preferably approximately 50 nm, very particularly preferably approximately 100 nm. Diameter ranges resulting from a combination of this maximum diameter and minimum diameter are particularly preferred. However, the globular, inert substances (spherical shape) have a preferred and more pronounced reinforcing effect. Core-shell particles, preferably having a spherical shape, can also be used as fillers.

Preferred fillers are selected from the group consisting of cement, silica, quartz, quartz sand, quartz powder, and mixtures of two or more thereof. For the purpose of chemical fastening, fillers selected from the group consisting of cement, fumed silica, in particular untreated, polar fumed silica, quartz sand, quartz powder, and mixtures of two or more thereof are particularly preferred.

Also suitable is the use of at least one powdered recycling material according to the previously unpublished European patent application EP 21 207137.7 (filing date Nov. 9, 2021) as a filler.

Further possible additives are also rheology additives, such as optionally organically or inorganically after-treated fumed silica (if not already used as a filler), in particular fumed silica after-treated in a non-polar manner, bentonites, alkyl- and methylcelluloses, castor oil derivatives or the like, plasticizers, such as phthalic or sebacic acid esters, stabilizers, antistatic agents, thickening agents, flexibilizers, hardening catalysts, rheological aids, wetting agents, coloring additives, such as dyes or in particular pigments, for example for different staining of the components for improved control of the mixing thereof, or the like, or mixtures of two or more thereof. Agents for regulating pH, such as inorganic and/or organic acids according to DE 102010008971 A1, in particular copolymers having acidic groups, e.g., esters of phosphoric acid, can also be used. Non-reactive diluents (solvents) such as lower-alkyl ketones, e.g., acetone, di-lower-alkyl lower-alkanoyl amides such as dimethylacetamide, lower-alkylbenzenes such as xylenes or toluene, phthalic acid esters or paraffins, or water, or glycols can also be present, preferably in an amount of up to 30 wt. %, based on the relevant component (reactive resin mortar, hardener), for example from 1 to 20 wt. %. Furthermore, agents for improving the compatibility between the resin component and the hardener component can also be used, such as ionic, nonionic or amphoteric surfactants; soaps, wetting agents, detergents; polyalkylene glycol ethers; salts of fatty acids, mono- or diglycerides of fatty acids, sugar glycerides, lecithin; alkane sulfonates, alkylbenzene sulfonates, fatty alcohol sulfates, fatty alcohol polyglycol ethers, fatty alcohol ether sulfates, sulfonated fatty acid methyl esters; fatty alcohol carboxylates; alkyl polyglycosides, sorbitan esters, N-methyl glucamides, sucrose esters; alkyl phenols, alkyl phenol polyglycol ethers, alkyl phenol carboxylates; quaternary ammonium compounds, esterquats, carboxylates of quaternary ammonium compounds.

In one embodiment, the reactive resin system may additionally contain an adhesion promoter. By using an adhesion promoter, the crosslinking of the borehole wall with the dowel compound is improved such that the adhesion increases in the cured state. This is important for the use of a dowel compound, e.g., in boreholes drilled with a diamond drill, and increases the failure bond stress. Suitable adhesion promoters are selected from the group of silanes which are functionalized with further reactive organic groups and can be incorporated into the polymer network. This group comprises, for example, 3-(meth)acryloyloxypropyltrimethoxysilane, 3-(meth)acryloyloxypropyltriethoxysilane, 3-(meth)acryloyloxymethyltrimethoxysilane, 3-(meth)acryloyloxymethyltriethoxysilane, vinyltrimethoxysilane, vinyltriethoxysilane, functionalized tetraethoxysilane, functionalized tetramethoxysilane, functionalized tetrapropoxysilane, functionalized ethyl or propyl polysilicate, and mixtures of two or more thereof. In this respect, reference is made to the application DE 10 2009 059210.

In a particularly preferred embodiment, the constituents of the reactive resin system are one or more of the constituents which are mentioned in the examples according to the invention. Reactive resins or reactive resin an/or hardener compositions which contain the same constituents or consist of the same constituents as are mentioned in the individual examples according to the invention, preferably approximately in the proportions stated in said examples, are very particularly preferred.

### Multi-Component Reactive Resin System

The reactive resin system according to the invention is preferably present as a multi-component reactive resin system, wherein a two-component reactive resin system is also comprised thereof. A multi-component system is to be understood in particular as a two-component system in which the components that are reactive to one another are included in such a way that they cannot lead to undesirable reactions during storage. In the case of a two-component system, this means, for example, that the system is a two-chamber device, i.e., the components (reactive resin component and hardener component) are thus present in chambers that are spatially separated from one another.

The invention therefore further provides a multi-component reactive resin system which contains the reactive resin system according to the invention, wherein the constituents of the reactive resin system are divided into the components such that they do not react with one another. Only when the components are mixed do the constituents react, so that the reactive resin cures. This means that the components of the hardener system according to the invention are divided among different components.

The preferred two-component reactive resin system consists of a reactive resin component (also reactive resin composition) and a hardener component (also hardener composition).

The reactive resin component comprises a reactive resin, a reactive diluent, in some cases an activator and in some cases a co-activator. One or more of the constituents can be contained in each case. Furthermore, the reactive resin component can comprise inorganic and/or organic additives and fillers.

In a preferred embodiment, the reactive resin component therefore comprises a reactive resin, at least one reactive diluent, an activator, in some cases a co-activator and inorganic and/or organic additives and also fillers.

If the hardener system and thus the multi-component reactive resin system contain a metal-based activator, it is contained in an amount of from 0.001 to 10 wt. %, preferably from 0.01 to 5 wt. % and particularly preferably from 0.05 to 2 wt. %, in each case based on the total weight of the reactive resin component.

If the hardener system contains a co-activator, such as saccharin, it is contained in an amount of 0.01 to 10 wt. %, preferably 0.01 to 5 wt. % and particularly preferably 0.1 to 5 wt. %, in each case based on the total weight of the reactive resin component.

The hardener component comprises an amine, in some cases at least one activator and in some cases at least one co-activator. Furthermore, the hardener component can comprise at least one reactive or non-reactive diluent, inorganic and/or organic additives and fillers.

The at least one activator can be contained in the hardener component and/or the reactive resin component. However, it is preferably contained in the reactive resin component in order to increase the storage stability of the multi-component reactive resin system.

The at least one co-activator can be contained in the hardener component and/or the reactive resin component. However, it is preferably contained in the hardener component in order to increase the storage stability of the multi-component reactive resin system.

The constituents of the reactive resin component and the hardener components of the multi-component reactive resin system according to the invention are as described above.

Furthermore, the hardener component may contain at least one reactive or non-reactive diluent. Suitable non-reactive diluents are liquid organic substances which do not contain ethylenically unsaturated double bonds; typically, but not exclusively, ethers or esters; preferably low-viscosity and high-boiling substances having a viscosity of less than 2000 mPas and a boiling point above 80° C.

Preferably, the non-reactive diluents are diesters of bifunctional carboxylic acids such as adipates or (also hydrogenated) phthalates. Likewise suitable are benzoates or esters of inorganic acids, such as organic phosphates. Further preferred are liquid polyalkylene glycols of suitable chain length (polyethylene glycols, polypropylene glycols and mixed polyalkylene glycols or mixtures thereof) which carry OH groups on the chain ends or are etherified or esterified.

Preference is given to dialkyladiates, dialkyl maleates or dialkyl succinates, and di- or trialkyl citrates or optionally hydrogenated dialkyl phthalates; for example diisononyl 1,2-cyclohexanedicarboxylate (DINCH) or mixtures of these or other plasticizers.

Also preferred are reactive diluents mentioned in EP 1352002 A1.

Reactive diluents which comprise ethylenically unsaturated double bonds are further preferred. Examples thereof are (meth)acrylic esters, styrene, α-methylstyrene, alkylated styrenes, such as tert-butylstyrene, divinylbenzene and vinyl and allyl compounds, wherein the representatives thereof that are not subject to labeling are preferred.

Non-radically homopolymerisable reactive diluents, such as vinyl or allyl compounds, are particularly preferred. Examples of these particularly preferred reactive diluents are hydroxybutyl vinyl ether, ethylene glycol divinyl ether, 1,4-butanediol divinyl ether, trimethylolpropane divinyl ether, trimethylolpropane trivinyl ether, mono-, di-, tri-, tetra- and polyalkylene glycol vinyl ethers, mono-, di-, tri-, tetra- and polyalkylene glycol allyl ethers which carry OH groups at the chain ends, or are etherified or esterified, adipic acid divinyl ester, trimethylolpropane diallyl ether and trimethylolpropane triallyl ether and mixtures of such substances with one another or with non-reactive diluents.

The proportion of the reactive resin in the reactive resin component is preferably from approx. 10 to approx. 70 wt. %, more preferably from approx. 10 to approx. 60 wt. %, even more preferably from approx. 10 to approx. 40 wt. %, based on the reactive resin component.

The reactive diluent or diluents are preferably present in the reactive resin in an amount to approx. 70 wt. %, particularly preferably from approx. 5 to approx. 60 wt. %, even more preferably from approx. 10 to approx. 50 wt. %, based on the reactive resin component.

The adhesion promoter is expediently contained in amounts of from approximately 1 to approximately 10 wt. %, based on the total weight of the reactive resin component.

The proportion of the enamine in the hardener component is preferably from approx. 1 to approx. 70 wt. %, more preferably from approx. 2 to approx. 50 wt. %, even more preferably from approx. 5 to approx. 30 wt. %, based on the total weight of the hardener component.

If the hardener system and thus the multi-component reactive resin system contain a metal-based activator, it is contained in an amount of from 0.01 to 10 wt. %, preferably of from 0.1 to 5 wt. % and particularly preferably 0.2 to 2 wt. %, in each case based on the total weight of the hardener composition.

If the hardener system contains a co-activator, e.g., saccharin, it is contained in an amount of 0.01 to 20 wt. %, preferably 0.1 to 10 wt. % and particularly preferably 0.5 to 10 wt. %, in each case based on the total weight of the hardener composition.

The proportion of the at least one reactive or non-reactive thinner in the hardener component is preferably from approx. 5 to approx. 70 wt. %, more preferably from approx. 10 to approx. 50 wt. %, even more preferably from approx. 20 to approx. 50 wt. %, based on the total weight of the hardener component.

It is also possible to divide the reactive resin system into three or more components. In this case, a multi-component reactive resin system results.

The mixing ratio of reactive resin and hardener component is in the range from 1:1 to 20:1, based on the volume of the components. Preferably, the mixture ratios are between 3:1 and 10:1, and mixing ratios from 5:1 to 10:1 are particularly preferred.

The multi-component reactive resin system according to the invention may be in the form of a cartridge system, a canister system or a film pouch system. In the intended use of the system, the components are either ejected from the cartridges or film pouches under the application of mechanical forces or by gas pressure, are mixed together, preferably by means of a static mixer through which the constituents are passed, and introduced into the borehole, after which the devices to be attached, such as anchor threaded rods and the like, are introduced into the borehole which is provided with the hardening reactive resin, and are adjusted accordingly.

The reactive resin system according to the invention is used primarily in the construction sector, for example for the repair of concrete, as polymer concrete, as a coating composition based on synthetic resin or as a cold-hardening road marking. Said system is particularly suitable for chemically fastening anchoring means, such as anchors, reinforcing bars, screws and the like, in boreholes, in particular in boreholes in various substrates, in particular mineral substrates, such as those based on concrete, aerated concrete, brickwork, limestone, sandstone, natural stone, glass and the like, and metal substrates such as those made of steel. In one embodiment, the substrate of the borehole is concrete, and the anchoring means consists of steel or iron. In a further embodiment, the substrate of the borehole is steel, and the anchoring means consists of steel or iron.

The reactive resin system according to the invention is in particular used to fasten anchoring means in boreholes of a different substrate and for structural bonding. In one embodiment, the substrate of the borehole is concrete, and the anchoring means consists of steel or iron. In a further embodiment, the substrate of the borehole is steel, and the anchoring means consists of steel or iron. Preferably, the steel borehole has grooves.

The invention is explained in greater detail in the following with reference to a number of examples. All examples and drawings support the scope of the claims. However, the invention is not limited to the specific embodiments shown in the examples and drawings.

### EMBODIMENTS

Unless stated otherwise, all constituents of the compositions that are listed here are commercially available and were used in the usual commercial quality.

Unless stated otherwise, all % data given in the examples relate to the total weight of the composition described, as a calculation basis.

TABLE 1
Raw materials used in the reactive resin components (A)

| | Description |
|---|---|
| Urethane methacrylate | Urethane methacrylate resin according to |
| | WO2019/007667, example C1 |
| | The resin was prepared and further used |
| | as a master batch in mixing with |
| | PEG-200DMA in a mass ratio of 35/65 |
| | (35.75/64.25). |
| 1,4-BDDMA | 1,4-butanediol dimethacrylate; trade name: |
| | Visiomer 1,4-BDDMA (Evonik) |
| TPGDMA | Tripropylene glycol dimethacrylate, Evonik |
| TCDDMA | Tricyclodecane dimethanoldimethyl |
| | methacrylate, trade name: SR 834 (Sartomer) |
| PEG200DMA | Polyethylene glycol (200) dimethacrylate; |
| | Trade name: Visiomer PEG200DMA |
| | (Evonik) |
| PEG400DMA | Polyethylene glycol (400) dimethacrylate; |
| | Trade name: Bisomer PEG400DMA (GEO) |
| MEMO | 3-methacryloxypropyl trimethoxysilane; |
| | dynasylan MEMO; Evonik |
| Morpholine | Tetrahydro-1,4-oxazine (SigmaAldrich) |
| Piperazine | 1,4-diazacyclohexane (SigmaAldrich) |
| Polyalkylene glycol | O,O′-bis-(2-aminopropyl) polypropylene |
| diamine | glycol block polyethylene glycol block |
| | polypropylene glycol-500 (SigmaAldrich) |
| Isobutyraldehyde | Isobutyraldehyde (SigmaAldrich) |
| Glutaraldehyde | Pentane-1,5,-dial (50% (SigmaAldrich) |
| Glyoxal | Edialal 50% (SigmaAldrich) |
| Acetone | Propanone (Roth) |
| 1-morpholino- | 1-morpholino cyclohexene (TCI Europe) |
| cyclohexene | |
| Diethyl adipate | Diethyl adipate (TCI Europe) |
| DINCH | Hexamoll DINCH (BASF) |
| Triethylcitrate | Triethylcitrate (Thermo Fisher) |
| Mn(acac)₂ | Manganese(II)acetylacetonate |
| | (SigmaAldrich) |
| Mn(acac)₃ | Manganese(III)acetylacetonate |
| | (SigmaAldrich) |
| Cu(acac)₂ | Copper(II)acetylacetonate (SigmaAldrich) |
| Copper(II)octanoate | Copper(II)ethylhexanoate (SigmaAldrich) |
| Octa-Soligen ® | Manganese salt solution (OMG, Borchers) |
| Manganese 10HS | |
| Octa-soligen ® Iron 7/8 | Iron salt solution (OMG, Borchers) |
| Borchers ® VP 0132 | Vanadium salt solution (OMG, Borchers) |
| TIB Kat ® 808 | Copper naphtenate solution (TIB Chemicals) |
| Borchers ® Deca | Copper decanoate solution (OMG, Borchers) |
| Copper 8 | |
| Saccharin | o-benzoenesulfide (SigmaAldrich) |
| Phthalimide | 1,3-dihydro-1,3-dioxoisoindole |
| | (SigmaAldrich) |
| MEHQ | 4-methoxyphenol (SigmaAldrich) |
| Me-Catechol | 4-methylcatechol (TCI Europe) |
| Triphenyl phosphite | Phosphoric acid triphenyl ester |
| | (SigmaAldrich) |
| Bz thiourea | Benzyl thiourea (TCI Europe) |
| Irgacure ® 1173 | 2-hydroxy-2-methylphenyl-propane-1-one |
| | (Ciba) |
| TEMED | N,N,N′,N′-tetramethyldiamine |
| | (SigmaAldrich) |
| Vestamin ® A139 | Blocked crosslinker for polyisocyanates |
| | based on cycloaliphatic diamines |
| PEG diimine | Condensation product of polyalkylene glycol |
| | diamine (Jeffamine ED600) and |
| | isobutyraldehyde according to |
| | WO22002567A1 |
| Tempol | 4-hydroxy-2,2,6,6-tetramethylpiperidinyloxyl; |
| | Trade name: 4-Hydroxy-TEMPO (BASF) |
| Cab-o-Sil ® TS720 | Hydrophobized fumed silica (Cabot) |
| Quartz sand F32 | Quartz sand (Quarzwerke Frechen) |
| Millisil ® W12 | Ground quartz (Quarzwerke Frechen) |
| TERNAL ® white | Calcium aluminate cement (Imerys SA) |
| BYK-P 105 | Low molecular weight unsaturated |
| | polycarboxylic acid polymer |
| | (BYK-Chemie GmbH) |
| BYK-378 | Polyether-modified polydimethylsiloxane |
| | (BYK- Chemie GmbH) |

### Preparation of the Enamines

Depending on the consistency of the raw materials, the condensation was carried out either in substance or in aqueous solution.

### Example of Morpholine/Isobutyraldehyde

8.7 g of morpholine were initially charged and 7.2 g of isobutyraldehyde were added in portions while stirring. The rate of addition must not be too high in order to avoid excessive buildup of heat. The reaction mixture was stirred overnight. The water formed remained in this case in the enamine formed.

### Example of Piperazine/Isobutyraldehyde

43 g of piperazine were dissolved at about 50° C. in 50 g of water, and 72 g of isobutyraldehyde were slowly added at this temperature. While stirring, the temperature was maintained at 80° C. for two hours. After cooling, the organic phase (enamine) was separated from the aqueous phase in the separating funnel and used for hardening experiments.

Further enamines (diethanolamine/isobutyraldehyde; morpholine/glutaraldehyde; piperazine/glyoxal aldehyde) were prepared analogously. Depending on the reactivity of the reactants, it may be necessary to apply heat longer. However, it is often not necessary to separate the water formed—for example by azeotropic distillation via a water separator—from the organic phase. In this case, the aldehyde was added in excess and distilled off after completion of the reaction.

### Execution of the Hardening Experiments

To test the suitability of components of the initiator system, some grams of a resin mixture (urethane methacrylate with reactive diluents) were initially charged in a roll edge column, metal salt (solid or in solution) was added and homogenized on the magnetic stirrer. When non-predissolved resins were used, the mixture was heated to about 50° C., and in some cases incompletely dissolved residue was left in the resin. After cooling to room temperature, the additives indicated in Table 2 and the enamine were added where applicable, and the vial was closed and shaken. Approximately every 5 min, the consistency of the content was checked and the time was noted until solidification t (Gel). The results are shown in Tables 2 to 5.

If poorly soluble reactants (such as saccharin) were used in the resin, the resin was thickened with a little silica (Cab-O-Sil® TS720) to prevent settling.

It is clear from the results shown in Table 2 that enamines are generally suitable as hardeners for methacrylates. Without additional co-activators, however, metal compounds with high redox potential are required.

It is apparent from the results shown in Table 3 that different co-activators are suitable for enabling the initiation of the polymerization even of metals with low redox potential.

Table 4 shows that various metal compounds can be used in order to ensure hardening by means of enamines with a suitable co-activator.

It can be seen from the results shown in Table 5 that various enamines are suitable for use as hardeners.

TABLE 2
Composition of the reactive resin compositions according to the invention and results of the hardening experiments (determination t(Gel))

| | Comparison 1 | Comparison 2 | Example 1 | Example 2 | Example 3 | Example 4 |
|---|---|---|---|---|---|---|
| Urethane methacrylate | 3.5 | 3.5 | 3.5 | 3.5 | 3.5 | 3.5 |
| 1,4-butanediol dimethacrylate | 2 | 2 | 2 | 2 | 2 | 2 |
| PEG200DMA | 2.5 | 2.5 | 2.5 | 2.5 | 2.5 | 2.5 |
| Octa-Soligen ® Manganese 10HS | | | 0.2 | | | |
| Mn(acac)2 | | | | 0.2 | | |
| Mn(acac)3 | | | | | 0.2 | |
| Borchers ® VP 0132 | | | | | | 0.2 |
| Octa-soligen ® Iron 7/8 | 0.2 | | | | | |
| TIB KAT ® 808 | | 0.2 | | | | |
| Morpholine/isobutyraldehyde | 0.5 | 0.5 | 0.5 | 0.5 | 0.5 | 0.5 |
| E° [V]*) | 0.77 | 0.15 | 1.54 | 1.54 | 1.54 | 0.99 |
| | Fe³⁺/Fe²⁺ | Cu²⁺/Cu⁺ | Mn³⁺/Mn²⁺ | Mn³⁺/Mn²⁺ | Mn³⁺/Mn²⁺ | VO₂⁺/VO²⁺ |
| t(Gel) [min] | — | — | 15 | 10 | 10 | 60 |

| | Comparison | Comparison | Example | Example | Example | Example | Example | Example | Example |
|---|---|---|---|---|---|---|---|---|---|
| | 3 | 4 | 5 | 6 | 7 | 8 | 9 | 10 | 11 |
| Urethane methacrylate | 2.2 | 2.2 | 2.2 | 2.2 | 2.2 | 2.2 | 2.2 | 2.2 | 2.2 |
| 1,4-butanediol dimethacrylate | 1.2 | 1.2 | 1.2 | 1.2 | 1.2 | 1.2 | 1.2 | 1.2 | 1.2 |
| PEG200DMA | 1.6 | 1.6 | 1.6 | 1.6 | 1.6 | 1.6 | 1.6 | 1.6 | 1.6 |
| MEHQ | | | 0.1 | | | | | | |
| Me-Catechol | | | | 0.1 | | | | | |
| Triphenyl phosphite | | | | | 0.1 | | | | |
| Phthalimide | | | | | | 0.1 | | | |
| Saccharin | | | | | | | 0.1 | | |
| Bz thiourea | | 0.1 | | | | | | | |
| Irgacure ® 1173 | | | | | | | | 0.1 | |
| TEMED | | | | | | | | | 0.1 |
| TIB KAT ® 808 | 0.1 | 0.1 | 0.1 | 0.1 | 0.1 | 0.1 | 0.1 | 0.1 | 0.1 |
| Cab-o-Sil ® TS720 | 0.1 | 0.1 | 0.1 | 0.1 | 0.1 | 0.1 | 0.1 | 0.1 | 0.1 |
| Morpholine/isobutyraldehyde | 0.5 | 0.5 | 0.5 | 0.5 | 0.5 | 0.5 | 0.5 | 0.5 | 0.5 |
| t(Gel) [min] | — | — | 60 | 2 | 60 | 120 | 5 | 70 | 70 |

| | Example 12 | Example 13 | Example 14 | Example 15 | Example 16 | Example 17 | Example 18 |
|---|---|---|---|---|---|---|---|
| Urethane methacrylate | 3.5 | 3.5 | 3.5 | 3.5 | 3.5 | 3.5 | 3.5 |
| 1,4-butanediol dimethacrylate | 2 | 2 | 2 | 2 | 2 | 2 | 2 |
| PEG200DMA | 2.5 | 2.5 | 2.5 | 2.5 | 2.5 | 2.5 | 2.5 |
| Saccharin | 0.2 | 0.2 | 0.2 | 0.2 | 0.2 | 0.2 | 0.2 |
| Octa-Soligen ® Manganese 10HS | 0.1 | | | | | | |
| Mn(acac)2 | | 0.1 | | | | | |
| Mn(acac)3 | | | 0.1 | | | | |
| Borchers ® Deca Copper 8 | | | | 0.1 | | | |
| TIB KAT ® 808 | | | | | 0.1 | | |
| Copper(II) acetylacetonate | | | | | | 0.1 | |
| Copper(II) octanoate | | | | | | | 0.1 |
| Cab-o-Sil ® TS720 | 0.1 | 0.1 | 0.1 | 0.1 | 0.1 | 0.1 | 0.1 |
| Morpholine/isobutyraldehyde | 0.5 | 0.5 | 0.5 | 0.5 | 0.5 | 0.5 | 0.5 |
| t(Gel) [min] | 60 | 10 | 10 | 15 | 20 | 35 | 30 |

| | Example 19 | Example 20 | Example 21 | Example 22 | Example 23 |
|---|---|---|---|---|---|
| Urethane methacrylate | 3.5 | 3.5 | 3.5 | 3.5 | 3.5 |
| PEG200DMA | 4.5 | 2.5 | 4.5 | 4.5 | 4.5 |
| PEG400DMA | | 2.0 | | | |
| Saccharin | 0.2 | 0.4 | 0.4 | 0.2 | 0.4 |
| TIB KAT ® 808 | 0.1 | 0.05 | 0.4 | 0.1 | 0.4 |
| Cab-o-Sil ® TS720 | 0.1 | 0.1 | 0.1 | 0.1 | 0.1 |
| Morpholine/isobutyraldehyde | 0.5 | 0.8 | | | |
| Piperazine/isobutyraldehyde | | | 0.4 | | |
| Diethanolamine/isobutyraldehyde | | | | 0.5 | |
| Morpholine/glutaraldehyde | | | | | 0.4 |
| t(Gel) [min] | 5 | 3 | 15 | 150 | 60 |

*)Petr Vanýsek; CRC handbook of chemistry and physics; 69^{th} Edition 1988-1989

### Preparation of Two-Component Mortar Compositions

### Preparation of the Reactive Resin Component

All constituents of the respective reactive resin components contained in Table 6 and activators and inhibitors were added to a plastic beaker and conducted on a magnetic stirrer at 50° C. until homogeneity of the mixture was achieved. After addition of the silica and the fillers, the mixture was briefly stirred by hand using a wooden spatula, and the component in the dissolver (PC laboratory system) was homogenized for 8 min at 3500 rpm under vacuum (80 mPa).

### Preparation of the Hardener Components

The hardener components used in the examples were prepared by all of the respective hardener components indicated in Table 5 being added and mixed in a dissolver (type LDV) for 8 minutes at 3500 rpm under vacuum at a pressure of 80 mbar and mixed together.

### Preparation of the Mortar Masses

To prepare the mortar compositions, the reactive resin component and the hardener component according to Tables 6 and 7, respectively, were each filled into hard cartridges in the specified volume ratio and applied via a static mixer (HIT-RE-M, Hilti) into the borehole.

### Preparation of the Comparative Reactive Resin Components and Hardener Components

The comparison reactive resin components and comparison hardener components were prepared in accordance with EP 3313896 B1, EP 3775017 A1 and WO 2022002567 A1. Since “additives” used there were not disclosed, commercially available thickeners were added.

### Measurement of Gel Time

The gel time of the mixture obtained in this way from the reactive resin and hardener components was determined using a commercially available device (GENNORM® Gel Timer) at a temperature of 25° C. For this purpose, the reactive resin component and the hardener component were mixed in the specified volume ratio, and the temperature of the sample was measured immediately after mixing. The sample itself is located in a test tube which is arranged with an air jacket in a silicone bath heated to 25° C.

### Determination of Load Values

To determine the load values of the cured composition, a high-strength anchor threaded rod M12, which was introduced into a borehole with a diameter of 14 mm and a borehole depth of 72 mm in C20/25 concrete after cleaning with compressed air (blown twice with 6 Bar) and fitting steel brush (brushed twice), as well as a repeated blowing out (twice 6 Bar) with the respective chemical mortar composition at about 20° C., were used.

The average failure load (R1) is determined by centrally pulling out the anchor threaded rod with close support. Five anchor threaded rods were each doweled and the load values were determined after a hardening time of 24 hours at room temperature. The mean load values determined in this case (average of the five measurements) are listed in Table 6 (below).

The determination of the failure load in the moist concrete (B7) was carried out analogously, wherein the boreholes were produced in the concrete stored for 4 weeks under water. The concrete block was only briefly removed from the water for the experiment. Cleaning took place here after drilling by one-time blowing out, brushing with the steel brush and in turn blowing out with compressed air at 6 bar.

TABLE 3
Composition of the reactive resin components

| | Comparison | Comparison | Comparison | Comparison | Example | Example | Example | Example | Example |
|---|---|---|---|---|---|---|---|---|---|
| Reactive resin component | 5A | 6A | 7A | 8A | 24A | 25A | 26A | 27A | 28A |
| Urethane methacrylate | 12.5 | 12.6 | 12.5 | 12.5 | 12.5 | 12.5 | 12.6 | 12.5 | 10.7 |
| PEG200DMA | 22.5 | 22.7 | 22.5 | 22.5 | 22.5 | 22.5 | 22.6 | 12.5 | 19.3 |
| TPGDMA | | | | | | | | 10 | |
| TCDDMA | | | | | | | | | 5.0 |
| MEMO | | | | | | | | | |
| TIB KAT ® 808 | 0.5 | 0.2 | 0.5 | 0.5 | 0.5 | 0.5 | 0.35 | 0.5 | 0.5 |
| Saccharin | | | | | | | 0.6 | | |
| BYK-P 105 | | | | | | | | | |
| BYK-378 | | | | | | | | | |
| 4-Hydroxy-TEMPO | | | | 0.04 | | | | | |
| Millisil ® W12 | 22.5 | 22.5 | 22.5 | 22.5 | 22.5 | 22.5 | 21.5 | 22.5 | 22.5 |
| Quartz sand F32 | 40 | 40 | 40 | 40 | 40 | 40 | 40.4 | 40 | 40 |
| TERNAL ® white | | | | | | | | | |
| Cab-o-Sil ® TS720 | 2 | 2 | 2 | 2 | 2 | 2 | 2 | 2 | 2 |
| Total | 100 | 100 | 100 | 100 | 100.0 | 100.0 | 100.0 | 100.0 | 100.0 |

| Reactive resin component | Example 29A | Example 30A | Example 31A | Example 32A | Example 33A | Example 34A |
|---|---|---|---|---|---|---|
| Urethane methacrylate | 10.2 | 12.2 | 12.5 | 12.6 | 12.6 | 12.5 |
| PEG200DMA | 18.3 | 21.8 | 22.5 | 20 | 22.6 | 22.5 |
| TPGDMA | | | | | | |
| TCDDMA | | | | | | |
| MEMO | | | | 2.6 | | |
| TIB KAT 808 | 0.5 | 0.5 | 0.5 | 0.35 | 0.5 | 0.5 |
| Saccharin | | | | | | |
| BYK-P 105 | | 1 | | | | |
| BYK-378 | | | | | | 1 |
| 4-Hydroxy-TEMPO | | | | | | |
| Millisil ® W12 | 22.5 | 22.5 | 22.5 | 17.5 | 22.5 | 22.5 |
| Quartz sand F32 | 47 | 40 | 40 | 40 | 40 | 39 |
| TERNAL ® white | | | | 5 | | |
| TS720 | 1.5 | 2 | 2 | 2 | 1.8 | 2 |
| Total | 100.0 | 100.0 | 100.0 | 100.0 | 100.0 | 100.0 |

TABLE 4
Composition of the hardener components and the comparative hardener component*)

| | Comparison | Comparison | Comparison | Comparison | Example | Example | Example | Example | Example |
|---|---|---|---|---|---|---|---|---|---|
| Hardener component | 5B | 6B | 7B | 8B | 24B | 25B | 26B | 27B | 28B |
| Diethyl adipate | 35 | 35 | 30 | 30 | 22.4 | 13.4 | 34.3 | 31.5 | 22.4 |
| DINCH | | | | | | | | | |
| Triethylcitrate | | | | | | | | | |
| Morpholine/isobutyraldehyde | | | | | 16 | 25 | 10 | | 16 |
| Piperazine/isobutyraldehyde | | | | | | | | 16 | |
| Vestamin ® A139 | 5 | 5 | | 10 | | | | | |
| PEG diimine | | | 10 | | | | | | |
| Saccharin | | 2 | | 4 | 4.8 | 4.8 | | 4 | 4.8 |
| Cab-o-Sil ® TS720 | 4 | 4 | 3.5 | 3.5 | 3.2 | 3.2 | 4.7 | 2.5 | 3.2 |
| Millisil ® W12 | 56 | 54 | 56.5 | 52.5 | 53.6 | 53.6 | 51 | 46 | 53.6 |
| Total | 100 | 100 | 100 | 100 | 100 | 100 | 100 | 100 | 100 |

| Hardener component | Example 29B | Example 30B | Example 31B | Example 32B | Example 33B | Example 34B |
|---|---|---|---|---|---|---|
| Diethyl adipate | 22.4 | 22.4 | | 32 | | 22.4 |
| DINCH | | | | | 30 | |
| Triethylcitrate | | | 30 | | | |
| Morpholine/isobutyraldehyde | 16 | 16 | 15 | 16 | 15 | 16 |
| Piperazine/isobutyraldehyde | | | | | | |
| Vestamin ® A139 | | | | | | |
| PEG diimine | | | | | | |
| Saccharin | 4.8 | 4.8 | 4 | 3.2 | 3.5 | 4.8 |
| Cab-o-Sil ® TS720 | 3.2 | 3.2 | 2.5 | 4 | 4 | 3.2 |
| Millisil ® W12 | 53.6 | 53.6 | 48.5 | 48.5 | 44.8 | 53.6 |
| Total | 100 | 100 | 100 | 100 | 100 | 100 |

*)Comparative examples based on EP 3 313 896 B1, EP3775017 A1 and WO2022002567A1

TABLE 5
Composition of the mortar compositions and results of the load value determinations

| | Comparison | Comparison | Comparison | Comparison | Example | Example | Example | Example | Example |
|---|---|---|---|---|---|---|---|---|---|
| | 5 | 6 | 7 | 8 | 24 | 25 | 26 | 27 | 28 |
| Mixing ratio | 5:1 | 5:1 | 5:1 | 10:1 | 5:1 | 10:1 | 10:1 | 5:1 | 5:1 |
| [Vol:Vol] | | | | | | | | | |
| Gel time [min] | 8 | 3.8 | 1 | 2.9 | 7.5 | 7.2 | 11 | 6 | 4.8 |
| @25° C. | | | | | | | | | |
| R1 [N/mm²] | 8.7 | 7.4 | 10.8 | 10.7 | 15.7 | 21.5 | 18.9 | 12 | 18 |
| B7 [N/mm²] | | | | 11.8 | 20.5 | | | | |

| | Example 29 | Example 30 | Example 31 | Example 32 | Example 33 | Example 34 |
|---|---|---|---|---|---|---|
| Mixing ratio [Vol: Vol] | 5:1 | 5:1 | 5:1 | 10:1 | 5:1 | 5:1 |
| Gel time [min] @25° C. | 5.4 | 8.3 | 5.8 | 21.5 | 2.9 | 7.6 |
| R1 [N/mm²] | 17 | 14.1 | 19.7 | 18.8 | 15.0 | 17.5 |
| B7 [N/mm²] | | | | | | |

1. A hardener system for a reactive resin system which contains radically polymerizable compounds, the hardener system comprising:
a) a compound of formula (I) 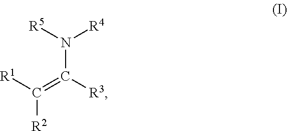
wherein
R¹, R² and R³ are, each independently of the other, a hydrogen atom, a linear or branched alkyl, linear or branched alkenyl, linear or branched alkylene, cycloalkyl, cycloalkenyl or ar(alk)yl group, wherein the cycloalkyl, cycloalkenyl and ar(alk)yl group each optionally contain at least one heteroatom and/or optionally be substituted,
R⁴ and R⁵ are, each independently of the other, a linear or branched alkyl, linear or branched alkenyl, linear or branched alkylene, cycloalkyl, cycloalkenyl or ar(alk)yl group, wherein the cycloalkyl, cycloalkenyl and ar(alk)yl group each optionally contain at least one heteroatom and/or optionally be substituted, or
R¹ and R², R¹ and R³, R² and R³ as well as R⁴ and R⁵ together form, each independently of the other, a cycloalkylene or cycloalkenyl group, which in each case optionally also contain heteroatoms in or on the ring and/or optionally be substituted,
and
b) a transition metal in the form of a salt or a compound.

2. The hardener system according to claim 1, wherein R¹, R² and R³ are, independently of one another, a hydrogen atom or a linear or branched alkyl group.

3. The hardener system according to claim 2, wherein R¹ and R² are, independently of one another, a linear or branched C₁-C₁₀-alkyl group, and R³ is a hydrogen atom or C₁-C₆-alkyl group.

4. The hardener system according to claim 3, wherein R¹ and R² are, independently of one another, a C₁-C₃-alkyl group and R³ is a hydrogen atom.

5. The hardener system according to claim 1, wherein R⁴ and R⁵ together form an alkylene, cycloalkylene or cycloalkenyl group, which optionally contains at least one heteroatom.

6. The hardener system according to claim 5, wherein R⁴ and R⁵ together form a heterocyclic cycloalkylene group having one heteroatom or two heteroatoms.

7. The hardener system according to claim 6, wherein R⁴ and R⁵ form a C₅-C₆-cycloalkylene group, which carries a nitrogen atom (N) and/or an oxygen atom (O) as heteroatoms.

8. The hardener system according to claim 1, wherein the transition metal is selected from the group consisting of copper, iron, vanadium, manganese, cerium, cobalt, zirconium, or bismuth, and mixtures of two or more thereof.

9. The hardener system according to claim 1, wherein the transition metal in the form of a compound is a transition metal carboxylate.

10. The hardener system according to claim 1, further comprising:
a co-activator.

11. An initiator system for a reactive resin system based on radically polymerizable compounds, the initiator system comprising:
a hardener system according to claim 1.

12. The initiator system according to claim 11, wherein the reactive resin system is one for chemical fastening.

13. A reactive resin system, comprising:
a hardener system according to claim 1, and
a radically polymerizable compound as a reactive resin.

14. The reactive resin system according to claim 13, wherein the radically polymerizable compound is selected from the group consisting of compounds based on urethane(meth)acrylate, compounds based on epoxy(meth)acrylate, methacrylates of alkoxylated bisphenols, compounds based on further ethylenically unsaturated compounds and combinations thereof.

15. The reactive resin system according to claim 13, further comprising:
organic and/or inorganic additives and/or fillers.

16. A multi-component reactive resin system with a resin component and a hardener component, wherein the resin component contains a radically polymerizable compound, a reactive diluent and a transition metal in the form of a salt or a compound, and the hardener component contains a compound of the formula (I) 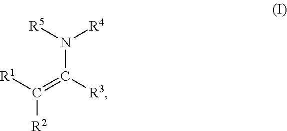
wherein
R¹, R² and R³ are, each independently of the other, a hydrogen atom, a linear or branched alkyl, linear or branched alkenyl, linear or branched alkylene, cycloalkyl, cycloalkenyl or ar(alk)yl group, wherein the cycloalkyl, cycloalkenyl and ar(alk)yl group optionally contain at least one heteroatom and/or optionally be substituted,
R⁴ and R⁵ are, each independently of the other, a linear or branched alkyl, linear or branched alkenyl, linear or branched alkylene, cycloalkyl, cycloalkenyl or ar(alk)yl group, wherein the cycloalkyl, cycloalkenyl and ar(alk)yl group each optionally contain at least one heteroatom and/or optionally be substituted, or
R¹ and R², R¹ and R³, R² and R³ as well as R⁴ and R⁵ together, in each case independently of one another, form a cycloalkylene or cycloalkenyl group which optionally each also contain heteroatoms in or on the ring and/or optionally be substituted.

17. The multi-component reactive resin system according to claim 16, wherein the reactive resin component and/or the hardener component further contain inorganic and/or organic additives and fillers.

18. A product, comprising:
a reactive resin system according to claim 13,
wherein the product is selected from the group consisting of an adhesive, a coating material and a molding compound.

19. A method, comprising:
fastening anchors in substrates with the reactive resin system according to claim 13.
